(19) United States
(12) Patent Application Publication
(10) Pub. No.: US 2010/0221695 A1
(43) Pub. Date: Sep. 2, 2010

(54) METHODS AND SYSTEMS FOR PERSONAL TRAINING

(76) Inventors: Nimesh Desai, Pacific Palisades, CA (US); Jake Steinfeld, Los Angeles, CA (US)

Correspondence Address: CHRISTINE JOHNSON ESQ., 151 Trenton Rd., Fairless Hills, PA, 19030, US

(21) Appl. No.: 12/396,403

(22) Filed: Mar. 2, 2009

(51) Int. Cl. G06F 19/00

(52) U.S. Cl. 434/428

(57) ABSTRACT

The invention provides a personal training system that delivers the benefits of personal training while overcoming the drawbacks cited above. The invention enables at least one trainee and at least one trainer to interact at mutually convenient times, and in a way that preserves the personal component of the training interaction. In that manner, the invention makes it possible for a trainer to deliver personal, interactive communication, personal support and timely motivation to a trainee. Thus the invention preserves the components of personal training that characterize successful personal training regimens, without imposing the inconveniences, expense and other drawbacks associated with on-site personal training approaches.

### FIELD OF THE INVENTION

The present invention relates generally to methods and systems for personal training.

### BACKGROUND OF THE INVENTION

Self improvement is a goal of many individuals. Some individuals seek to improve themselves by increasing mental and physical health and fitness. Some seek to improve by increasing knowledge, education or skill in specific areas of interest, for example, in a particular sport or recreational activity. Many self improvement goals call for changes to an individual's habits, actions or behaviors. Behavior changes can range from a change in eating and exercise habits for a dieter to a change in swing mechanics for a golf or tennis player.

Regardless of the type of personal improvement desired, success in achieving a personal improvement goal relies on two important resources. The first is an individual's access to reliable information about the steps that will be effective in achieving the goal. The second is the individual's ability and motivation to change personal habits and behaviors so as to follow the effective steps until the goal is achieved. Many individuals find the greatest challenges to achieving their improvement goals are maintaining motivation and changing habits and behaviors.

Personal training has long been recognized as a highly effective means by which an individual can reach a self improvement goal. A skilled personal trainer can assist an individual in articulating a goal. A knowledgeable trainer can evaluate an individual's starting position and identify the most effective steps to reach the individual goal. Personal attention by a compatible trainer can identify problem areas and modify steps in accordance with the trainer's observations of a trainee while accounting for the trainee's individual strengths and weaknesses.

Perhaps the most important benefit of a personal trainer is derived from the interpersonal interaction and personal relationship developed between an individual trainee and a compatible personal trainer. For many individuals real time interpersonal interaction with a compatible trainer is the key to breaking old habits, changing defeating behaviors, maintaining motivation and achieving success.

However, personal training has drawbacks. One drawback of personal training is the expense of hiring a personal trainer. Cost alone makes personal training unavailable to many individuals. Another drawback of personal training is the challenge of finding a trainer skilled in the area of interest to the trainee and at the same time, personally compatible with the trainee's personality, preferences and lifestyle. Yet another drawback of personal training is the difficulty of scheduling training sessions between a trainee and a trainer. The most compatible trainer for a given trainee may live in a city, or even a country inaccessible to the trainee on a daily basis. Both trainer and trainee may have busy lifestyles with many conflicts in availability. The challenges of scheduling personal training sessions, coupled with the burden of travel to and from a training site remove personal training as an option for many individuals.

The problems mentioned above can discourage trainers and trainees from participating in the market for personal training services. These problems impose limits on the amount of interactive, person to person, on demand communication that can take place between a trainer and a trainee. Yet, this is the very type of communication, interaction and support that is most effective in maintaining a trainee's motivation and changing trainee behaviors.

Many individuals who could benefit from personal training do not have the resources for deploying a personal trainer in their homes, offices and gymnasiums to provide timely reminders, guidance and corrective feedback throughout the day. On the other hand, many skilled trainers have a limited pool of trainees to whom their expertise and services can be provided. When a training plan calls for personal trainer visits to a training site, distance and time factors limit the number of trainees a single trainer can manage.

The inventors have recognized the problems described above and have provided a system and method for personal training to overcome these obstacles. The invention provides a personal training system that delivers the benefits of personal training while overcoming the drawbacks cited above. The invention enables at least one trainee and at least one trainer to interact at mutually convenient times, and in a way that preserves the personal component of the training interaction without the need for the trainer and the trainee to be physically co-located. Thus the invention preserves the components of personal training that characterize successful personal training regimens, without imposing the inconveniences, expense and other drawbacks described above.

### DESCRIPTION OF THE DRAWING FIGURES

These and other objects, features and advantages of the invention will be apparent from a consideration of the following detailed description of the invention considered in conjunction with the drawing figures, in which:

FIG. 1 is block diagram of a training system according to an embodiment of the invention;

FIG. 2 is a block diagram of a matching unit and training console generators according to an embodiment of the invention;

FIG. 3 illustrates a portion of a trainee console according to an embodiment of the invention;

FIG. 4 illustrates a portion of a trainer console according to an embodiment of the invention;

FIG. 5 is a block diagram of a communication subsystem according to an embodiment of the invention.

FIG. 6 is a block diagram of a training system according to an embodiment of the invention;

FIG. 7 illustrates a display portion of a trainer's console according to an embodiment of the invention;

FIG. 8 illustrates a display portion of a trainee's console according to an embodiment of the invention;

FIG. 9 is a flowchart illustrating steps of a matching method according to an embodiment of the invention;

FIG. 10 is a flowchart illustrating steps of a communication method according to an embodiment of the invention;

FIG. 11 is a pictorial diagram illustrating a trainee system configured for communication with more than one trainer system according to an embodiment of the invention;

FIG. 12 is a flowchart illustrating steps of a method for generating a training plan according to an embodiment of the invention;

FIG. 13 is a pictorial diagram illustrating a system of the invention configured for implementation in a remote gymnasium according to an embodiment of the invention;

FIG. 14 is a pictorial diagram illustrating a system of the invention configured to implement remote training according to an embodiment of the invention.

FIG. 15 is a flowchart illustrating steps of a method for remote training according to an embodiment of the invention.

FIG. 16 illustrates an embodiment of the invention including a training plan and a sensor for providing data to update the training plan data.

### DETAILED DESCRIPTION OF THE INVENTION

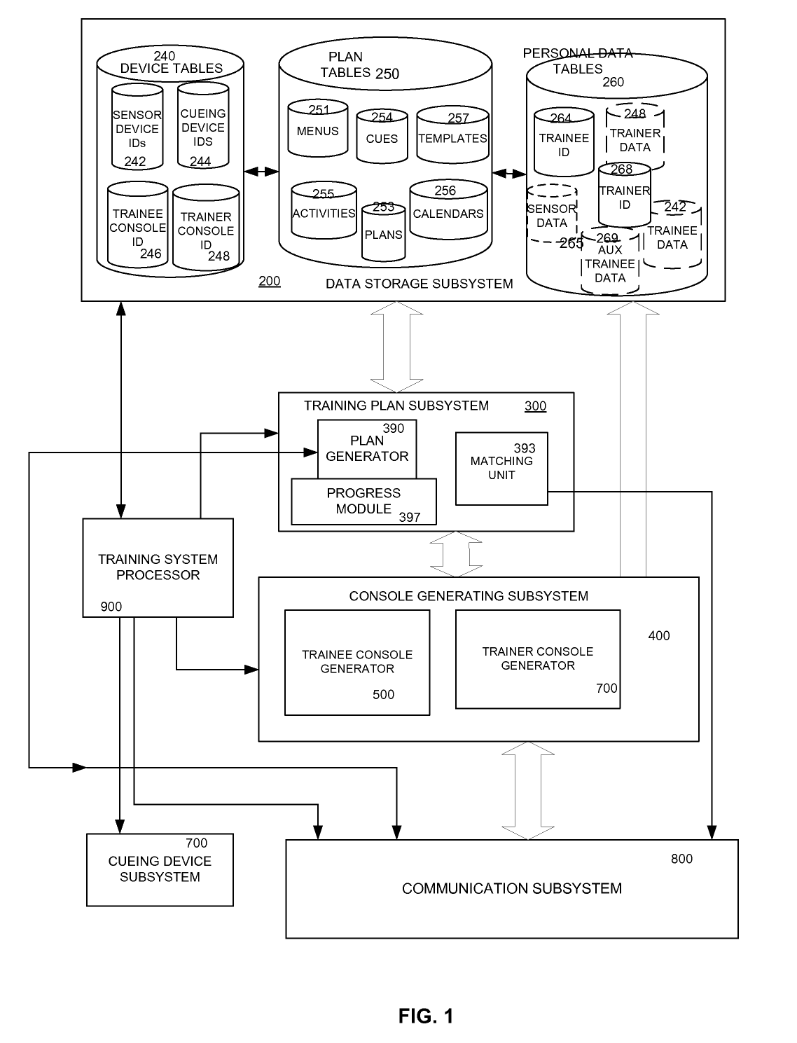

### FIG. 1 System Overview

FIG. 1 is block diagram of a training system 100 according to an embodiment of the invention.

### Data Storage Subsystem 200

Training system 100 includes a data storage subsystem 200. Various embodiments of data storage subsystem 200 are implementable using Random Access Memory (RAM) devices, Read Only Memory (ROM) devices, magnetic, LASAR, Blue Ray and other optical disk storage devices, and other types of memory and storage devices. Any data storage device capable of receiving data, storing the received data and retrieving the stored data in response to commands from the subsystems and units comprising training system 100, in accordance with the detailed description below, is suitable to implement memory subsystem 200.

Data storage subsystem 200 operates under control of training system processor 900 to send and receive data to and from a console generating subsystem 400 and a training plan subsystem 300. In various embodiments contemplated for the invention, suitable electronic coupling is established, for example, via at least one of wired and wireless connections. For example, optical and radio frequency connections, Ethernet and Internet enabled connections, and many other types of connections are suitable for implementing various embodiments of the invention. Any connection type that enables memory system 200 to receive, store and provide data, in the various forms described in detail herein, to and from training plan subsystem 300 and console generating subsystem 400 is suitable for coupling memory subsystem 200 to training plan subsystem 300 and console generating subsystem 400.

### Training Plan Subsystem 300

Training plan subsystem 300 comprises a plan generator 390 and a matching unit 393.

### Plan Generator 390

Plan generator 390 comprises templates, tools and interfaces enabling a trainer to operate system 100 via a trainer console to provide a customized training plan to a trainer console of a trainee. Training plan subsystem 300 is configured to provide and receive the signals described herein, to and from console generating subsystem 400 under control of processor 900.

### Matching Unit 393

In response to system 100 receiving a request for a trainer from a trainee system, matching unit 393 retrieves information about trainers from trainer data storage 248 of data storage subsystem 200. In one embodiment of the invention matching unit 393 retrieves trainer information from trainer data storage 248 based on matching criteria received from the trainee computer system. In one embodiment of the invention, matching unit 393 compares the received trainee criteria to the stored trainer data based on the matching criteria. Matching unit 393 retrieves trainer data meeting the matching criteria. Matching unit 393 provides the retrieved trainer data to the trainee system.

In one embodiment of the invention, matching unit 393 retrieves trainer information from trainer data storage 248 based on matching criteria received from a trainee computer system. Matching unit 393 further retrieves trainee information from trainee data storage 242 based on matching criteria received from a trainer computer system. If the trainer data and the trainee data meet both matching criteria, matching unit 393 provides an indication of matching trainees and trainers. For example, Jones, a 38 year old male trainee provides a request for a trainer. The request includes matching criteria. The matching criteria include female trainers. Doe, a female trainer provides a request for trainees. The request includes matching criteria. The matching criteria include 38 year old trainees. In that case, matching unit 393 provides an indication that Jones and Doe are a matched trainee and trainer.

Matching unit 393 provides retrieved trainer information to matched trainee computer systems. In some embodiments of the invention matching unit 393 retrieves information about trainees from trainee data storage 242 based on matching criteria received from a trainer computer system. In that case, matching unit 393 provides the retrieved trainee information to matched trainer computer systems.

Matching unit 393 provides the match indicating signal to console generating subsystem 400. The matching signal indicates matched trainers and trainees. In one embodiment of the invention a matching signal includes console identifiers for matched trainers and trainees, along with identifiers of matching trainers and trainees.

Matching unit 393 retrieves trainee data stored in trainee data storage 242. Matching unit 393 retrieves trainer data stored in trainer data storage 248. In one embodiment of the invention matching unit 393 further receives first matching criteria from a trainee console. The first matching criteria define characteristics of a trainer. Matching unit 393 retrieves trainer data from data storage 248 based on the matching criteria. According to some embodiments of the invention matching unit 393 receives second matching criteria from a trainer console. The second matching criteria define characteristics of a trainee. Matching unit 393 retrieves trainee data from data storage 242 based on the second matching criteria. In one embodiment of the invention matching unit 393 retrieves trainee data and trainer data based on the first and second matching criteria.

### Console Generating Subsystem 400

Console generating subsystem 400 comprises a processor configured in accordance with this specification to send and receive signals to and from trainee and trainer computer systems. The signals configure the trainee and trainer computer systems as trainee and trainer consoles, respectively. In one embodiment of the invention console generating subsystem 400 comprises a server configured to serve interactive web pages to trainer and trainee computer systems in response to requests from the trainee and trainer computer systems received via the Internet.

In that embodiment, trainee console generator 500 generates trainee consoles comprising interactive web pages implementing controls, indicators, and displays on a trainee computer system. The trainee controls indicators and displays enable a trainee to operate the trainee's computer system to interact with at least one matched personal trainer via system 1 00. Likewise, trainer console generator 700 generates trainer consoles comprising interactive web pages implementing trainer controls indicators and displays enabling a trainer to operate the trainer's computer system to interact with at least one matched trainee via system 100.

Further, console generating subsystem 400 is configured to receive data from the trainer and trainee consoles, and to provide the data to appropriate storage units of data storage subsystem 200. In that manner system 100 provides a trainer console and a trainee console that enable a trainee and a trainer to conduct interactive personal training sessions. The training system further provides a personal training plan designed by a trainer to accomplish a matched trainee's training goals. In some embodiments of the invention, the personal training plan is based, at least in part, on trainer data provided by a trainer via trainer console system. The trainer data represents the trainer's modifications of a template training plan. The modifications are based on the trainer's interaction with the trainee using system 100.

### Communication Subsystem 800

A communication subsystem 800 is configured to enable the subsystems of training system 100 to communicate with a plurality of trainee and trainer computer systems and other electronic trainer and trainee devices to implement the functions and features of the embodiments of the invention described herein. In many embodiments, trainer and trainee systems and devices are remote from training system 100. For example, the trainee and trainer computer systems and devices may be located in a city, state, or country different from the location of training system 100. Signals as described herein, between communication subsystem 800 and remote trainer and trainee systems and devices, are conveyed using suitable communication links.

For example, embodiments of the invention enable communication via the Internet, via cellular telephony communication networks, via radio frequency communication links, broadcast and cable television channels, satellite communication links, cable communication links and other types of communication links suitable for transmitting those signals which implement the unique functions and features of training system 100 as described in detail herein.

### System Processor 900

A training system processor 900 is configured to control the operation of the subsystems described above, and their corresponding components to implement the functions and features of the embodiments of the invention described herein. This specification includes flowcharts describing how processor 900 can be configured to control the subsystems and components of system 100 to operate in accordance with this specification.

### Cueing Device Subsystem 700

Cueing device subsystem 700 cooperates with training plan generator 390 to provide training cues to a cueing device of a trainee. For purposes of this specification a training cue is any visual, audible, tactile or other stimulus related to a training plan and provided to a trainee in a form perceptible by the trainee. A cueing device refers to any device carried by a trainee or on the person of a trainee capable of receiving signals conveying cues.

In an example embodiment of the invention, plan generator 390 generates a cue comprising a text message to communication subsystem 800. Communication subsystem 800 sends the text message to a trainee's cellular telephone. The text message prompts the trainee to take some action related to the trainee's training plan. For example, a message reminding a trainee to take medication is sent to the trainee's cellular telephone. In some embodiments the trainee is provided with additional information such as dosage to be taken. In other embodiments of the invention system 100 generates cueing signals which, when received by a trainee's cueing device, causes the device to initiate buzzers, alarms, vibrations or other indicators related to the trainees training plan.

The timing of the transmission of a cue from system 100 to a trainee's cueing device is determined in accordance with a training plan component of a training plan. For example a training plan including a medication schedule component incorporates cues associated with the scheduled time for taking a medication. The cues are generated by plan generator 390 in accordance with the schedule.

In one embodiment of the invention, system 100 is configured to receive a trainee response to a received cue. For example, after a trainee receives a cue to take medication, the trainee replies to the message indicating that the action, in this case, taking the medication, was completed. The trainee's responses are stored in the trainee's training data storage. In one embodiment of the invention, training plan generator 390 updates a training plan in response to receiving trainee cue responses. In some embodiments of the invention training plan generator 390 generates a report including the cues and the responses for a trainee or a trainer. The report is provided to console generating subsystem 400 and provided as a graphical, textual or other indicator to a trainer, or trainee console.

Other personal devices are suitable for use as cueing devices in conjunction with various embodiments of the invention. Personal digital assistants (PDA), pagers and other wired and wireless devices will find application as cueing devices in various embodiments of the invention.

### Details—Data Storage Subsystem 200

FIG. 1 illustrates data storage subsystem 200 comprising a plurality of tables (240. 250, 260). According to embodiments of the invention, system 100 transforms the data comprising the data tables into customized training plans and training plan components based on interaction between trainers and trainees. In one example embodiment, data storage subsystem 200 comprises personal data tables 260, training plan data tables 250 and training device tables 240.

### Personal Data Tables

Example personal data tables 260 comprise trainee data items 242, trainer data items 248, trainer identifiers 268, trainee identifiers 264, auxiliary trainee data items 268 and sensor data items 265.

In one embodiment of the invention, personal data tables include sensor data items. Trainee data items include items of information about a trainee that are capable of association by system 100 with training plan subsystem 300. Training plan subsystem 300 generates that trainee's training plan based on the associated trainee data items.

For example, system 100 provides data items 242 representing a trainee's weight information from memory subsystem 200 to training plan subsystem 300. Training plan subsystem 300 generates a training plan for that trainee by transforming the data items into a weight reduction component of a training plan suitable for that trainee. In another example, training plan subsystem 300 transforms data items related to a trainee's blood pressure into a health improvement component of a training plan. In another example, training plan subsystem 300 transforms data items representing a trainee's stress level into a stress reduction component of a training plan.

Other types of trainee personal data items 242 relevant to various training plan components will be readily appreciated by those of ordinary skill in the art upon reading this specification. The invention provides a training plan subsystem 300 capable of generating a wide variety personal training plan components by transforming a wide variety of corresponding trainee personal data items including nutrition and diet data items, exercise data items, trainee personal preference data items and the like. In one embodiment of the invention personal data tables include trainee data items stored in auxiliary data item tables 269. Auxiliary data item tables include data items received from external databases and sources of trainee personal data from systems other than a trainee system. For example, trainee physical and physiological data items, geographic and demographic data items, medical data items and the like are received from a medical or other third party database.

In one embodiment of the invention, system 100 is configured to enable a trainer to enter trainee personal information data items into trainee personal data item tables 242 for storage. For example, in one embodiment of the invention, system 100 enables a trainer to input trainee personal data items that represent a trainer's observations or conclusions about a trainee based on the trainer's expertise. In one embodiment of the invention, system 100 configures a communication link between a trainer system, a trainee system and system 100 such that a trainer is enabled to enter trainee personal data items while observing, or otherwise communicating with the trainee via the communication link.

In one embodiment of the invention, system 100 transforms selected portions of specific, diverse individual pieces of trainee personal data stored in personal data tables 260 to form a comprehensive training plan comprising a plurality of training plan components. In one embodiment of the invention, system 100 transforms at least a portion of these discrete pieces of trainee personal data items into signals comprising cues, i.e., stimulus signals in a form suitable for transmission. For example, embodiments of the invention contemplate transmitting cues via cellular telephony networks, radio frequency transmission links, internet communication links and short range transmission links such as Bluetooth and WIFI links, and combinations of such links.

System 100 transmits these stimulus signals for reception by a trainee cueing device. Examples of trainee cuing devices include cellular telephones, personal digital assistants, pagers, portable computers and any other portable device suitable for transport by a trainee. Any device configurable to receive a cueing signal from system 100 and to transmit the received cue to the trainee is suitable for use in embodiments of the invention. Examples of cues include audible and visual alarms and indicators, tactile indicators including vibrations, and other biological and physical stimuli. Thus the trainee is assisted in adhering to a training plan regimen to achieve his or her training goal.

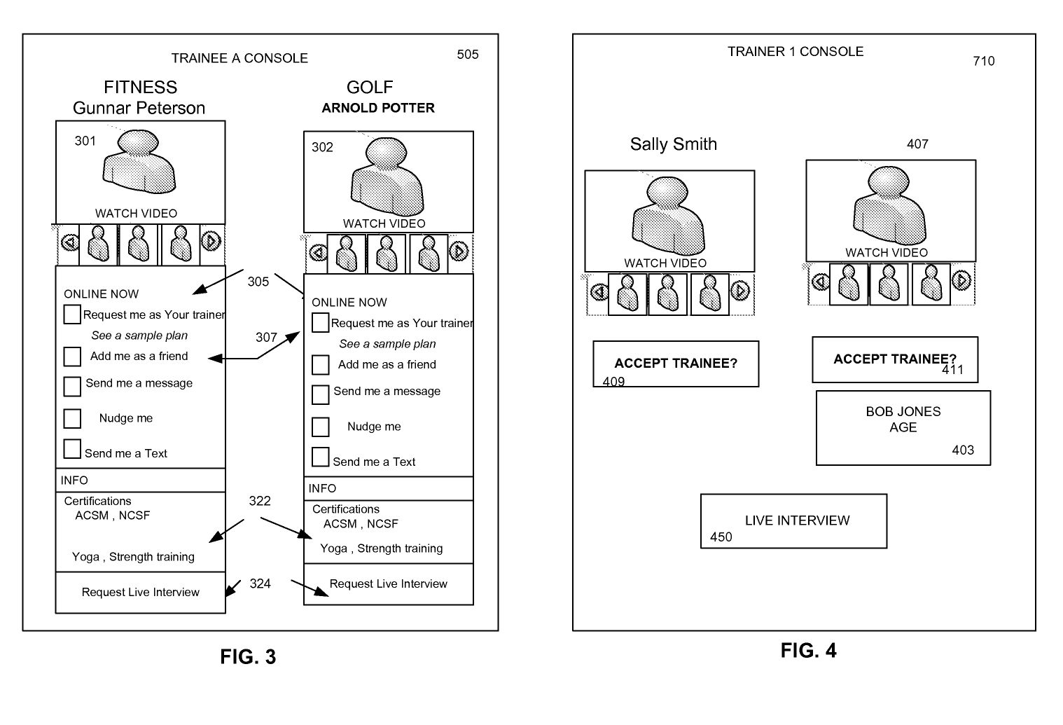

Personal data tables 260 further include trainer data 248. Examples of trainer data items include trainer age, gender, geographic location, trainer specialties, experience and preferences. In one embodiment of the invention training plan subsystem 300 includes a matching unit (example illustrated in FIG. 3 at 393). Matching unit 393 is provided with at least a portion of trainee and trainer personal data items stored in personal data tables 260. Matching unit 393 compares the data items and provides a signal indicating a correspondence, such as a matching indicator, based on the data item comparison. The configuration and operation of matching unit 393 is explained in greater detail below.

In one embodiment of the invention personal data tables 260 store sensor data items 265. Sensor data items are data items provided by biological and physical sensors associated with a trainee. The sensed data items represent biological, physical, mechanical and other parameters useful for characterizing a trainee within the context of a training plan. For example, a trainee wears a heart rate monitor while performing a component of a training plan. The training console implemented on the trainee's computer system receives heart rate data transmitted by the heart rate monitor. The training console provides the heart rate data to system 100, for example via the Internet. System 100 stores the heart rate data as heart rate data items in sensor data storage 265.

### Plan Data Tables 250

Data storage subsystem 200 further includes plan table storage 250. Plan tables include template plan data items 257. Template plan data items 257 define particular training plans or training plan components used as a basis for personalized training plans. For example, in one embodiment of the invention a set of template plan data items relating to menu items define a template for a diet component of a weight loss training plan. Similarly a set of template plan data items relating to basic stretching exercises define a template for an exercise component of the weight loss training plan.

According to some embodiments of the invention, plan table storage 250 further includes menu data items 251. Menu data items 251 include pre-defined menus defining, for example, a variety of meals to be incorporated in a training plan template.

Training plan subsystem 300 cooperates with data storage subsystem 200 and console generating subsystem 400 to provide a template training plan in response to system 100 receiving a trainer template selection signal from a trainer console. In that manner system 100 enables a trainer to select a template training plan at the initiation of the trainer's communication with a trainee. Once a trainer selects a template, system 100 enables the trainer, and in some embodiments a trainee, to adjust and reconfigure the template in accordance with trainee personal data items to define a personalized training plan.

### Device Data Tables 240

Data storage subsystem 200 further includes device table storage 240. Device table storage 240 includes device data items. Device data items identify devices associated with training system 100. For example, in some embodiments of the invention, system 100 incorporates cues into a training plan. In that case, cueing devices such as cell phones, PDAs and pagers are identified by corresponding device identifiers. In some embodiments of the invention, devices such as video cameras, microphones, sensor devices and other devices are associated with a trainee or a trainer system. In that case each device is identified by a corresponding device identifier.

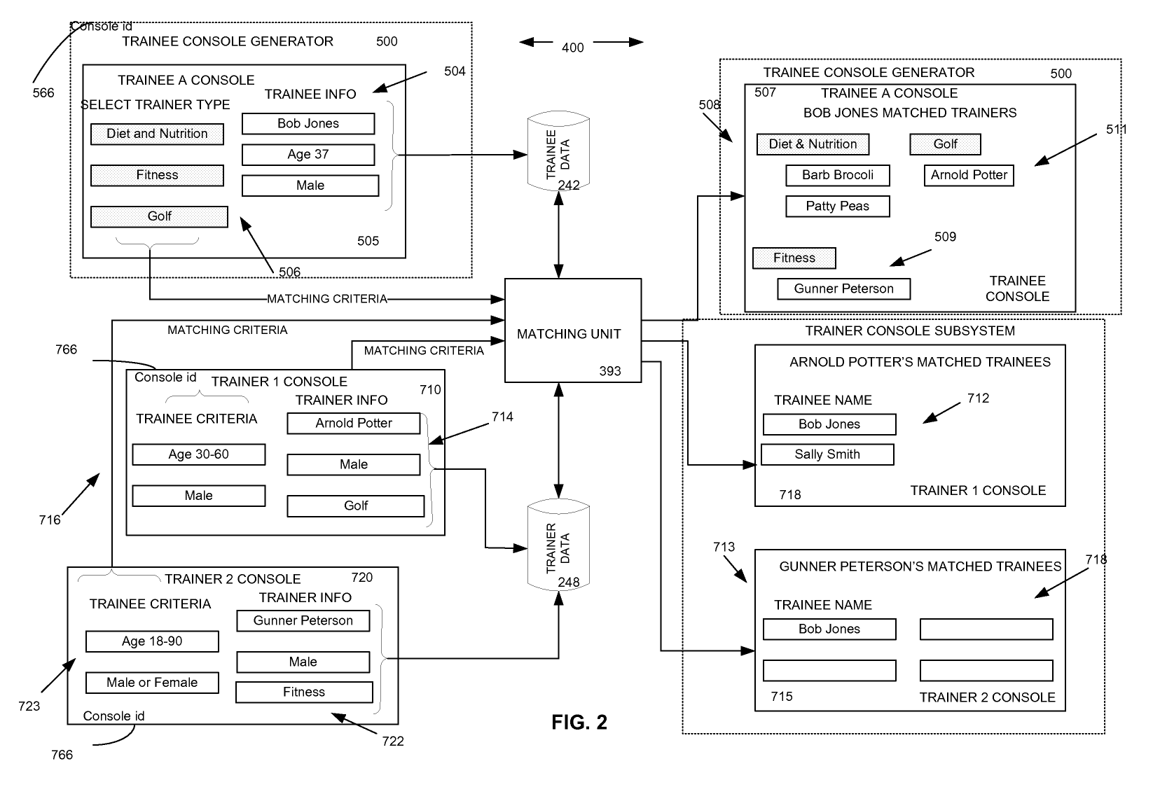

### FIG. 2 Console Generating Subsystem 400—Detailed Description

FIG. 2 is a block diagram of a training console generator subsystem 400 coupled for cooperation with matching unit 393 according to an embodiment of the invention. Trainee console generator subsystem 400 comprises a trainee console generator 500 and a trainer console generator 700. Trainee and trainer console generators according to embodiments of the present invention generate consoles comprising configuration instructions for configuring remote trainee or trainer computer systems and devices. The consoles provided by console generator subsystem 400 are provided to a trainee or trainer computer via a communications link, for example, the Internet.

The console configuration instructions configure a receiving computer system to operate as a training console in accordance with the operational descriptions and specifications provided herein. System 100 assigns each trainee console a unique console identification number, for example console id 560 for trainee console 505. Likewise each trainer console is identified by a trainer console identification number, for example console id 766 for trainer console 710. Console identification numbers are stored in device tables 240 of data storage unit 200 (best illustrated in FIG. 1.)

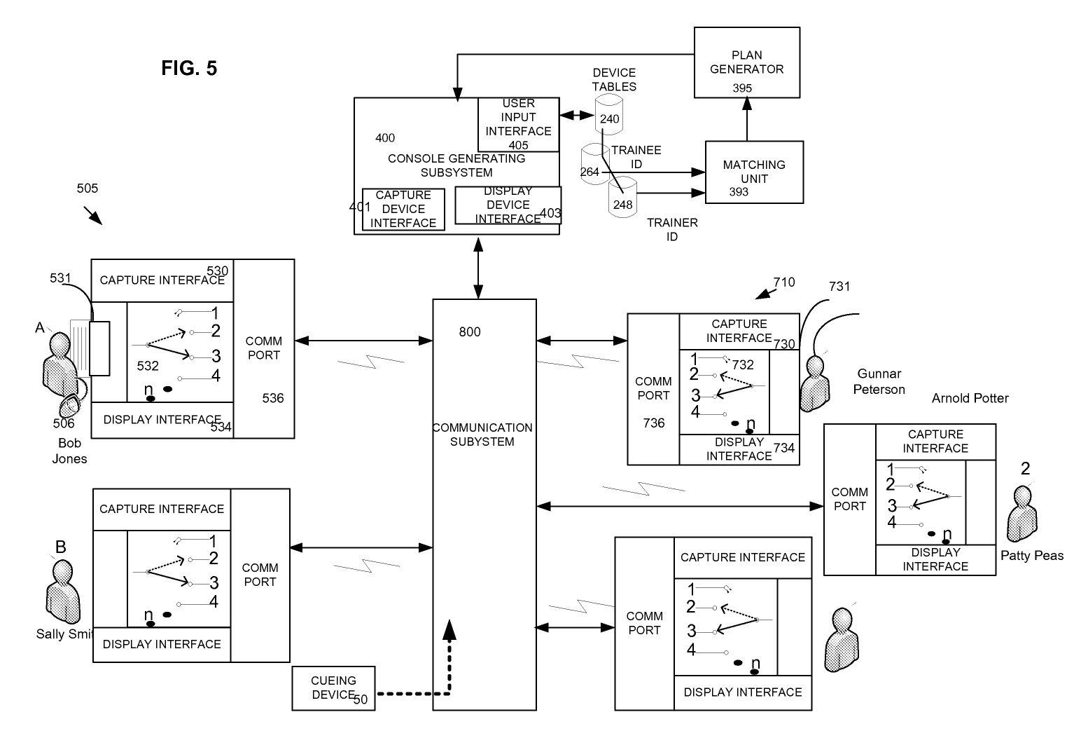

FIG. 5 illustrates examples of trainee and trainer consoles according to an embodiment of the invention. A computer system of an example trainee “A” receives a trainee console 505 from system 100. In one embodiment of the invention, an example trainee console 505 comprises a capture device interface 530, a display device interface 534, selector switches 532, keyboard interface 531 and mouse interface 506. Trainee console 505 includes a graphical user interface 536 configured to generate the visual and interactive components of trainee console 505 and to display console portions on corresponding portions of a display device comprising a trainee's computer system.

Likewise, an example trainer “1” receives a trainer console from system 100. According to one embodiment of the invention, example trainer console 710 comprises a capture device interface 730, a display device interface 734, selector switches 732, keyboard interface 731 and mouse interface 706. Trainer console 710 includes a graphical user interface 736 configured to generate the visual and interactive components of trainer console 710 and to display console portions on corresponding portions of a display device comprising a trainee's computer system.

Examples of suitable capture devices include video, audio, text, graphics, keystroke, mouse movement and other input devices. Typical commercial video cameras, cellular telephones, microphones, keyboards, mouse devices, trackballs and other input devices are suitable for use in the various embodiments of the invention. The interfaces comprising trainer and trainee consoles enable a trainee to interact with the console to send and receive data and information to and from system 100.

Returning now to FIG. 2, matching unit 393 cooperates with training console generator subsystem 400 to generate training consoles which enable trainees, and trainers to provide information and data to system 100. Training consoles further enable trainees and trainers to receive information and data from system 100. For example, during an initial process trainee console generator 500 generates trainee console 505 and trainer console generator 700 generates trainer console 710. A trainee console is provided to a trainee system via a communication link established by communication subsystem 800 (best illustrated in FIG. 5). Likewise a trainer console is provided to a trainee system via a communication link established by communication subsystem 800 (best illustrated in FIG. 5.)

### Trainee Console 505

FIG. 2 illustrates data input portions 504 of trainee console 505 configured for operation by trainee “A”. Data input portions 505 enable a trainee to enter trainee data, for example, name (example name Bob Jones is trainee “A”), age (Bob Jones is 37) and gender (bob Jones is male). The example of FIG. 2 illustrates three items of trainee information in fields 504. However, trainee console 505 is configurable by system 100 to enable more or less fields 504 and thus more or less items of trainee information to be provided. The trainee data is provided by trainee console 505 to system 100. In one embodiment of the invention the data is provided to communication subsystem 800 of system 100 via the Internet. System 100 receives and stores the data as trainee data item values in trainee data tables 242.

Trainee console 505 further provides trainer criteria data input portions 506. Trainer criteria data input portions 506 enable a trainee to indicate preferences for trainer characteristics. In other words, trainee console 505 further enables a trainee to specify at least one “type” of trainer desired. Some embodiments of the invention enable a trainee to be matched with a single trainer of a type selected by the trainee. After matching, execution of a training plan is carried out through cooperation of the single trainer and the trainee via system 100. However, other embodiments of the invention enable a trainee to select more than one trainer. In the example of FIG. 2, a trainee indicates a desire for three trainers, one trainer specializing in diet and nutrition, another trainer specializing fitness and another trainer specializing in golf.

While only three trainer types are illustrated in FIG. 2, other embodiments of the invention enable trainee selection of more or fewer numbers of trainers and characteristics of desired trainers. The trainer criteria data received by console 505 from a trainee is provided by trainee console 505 to system 100, for example via the Internet as described above. System 100 receives the trainer criteria data via communications subsystem 800 and provides the trainer criteria data to matching unit 393.

While consoles are illustrated for only one trainee in FIG. 2, it will be apparent upon reading this specification that a virtually unlimited number of trainee consoles are possible in various embodiments of the invention. The trainee consoles provided by system 100 enable a plurality of trainees to interact with system 100 using the trainees' respective computer systems as configured by training consoles provided by training console generator 400.

### Trainer Console 710

In a similar manner an example trainer console 710 enables a trainer to use the trainer's computer system to provide trainer information to system 100 via console input fields 514. The example illustrates a trainer “1” named Arnold Potter and a trainer “2” named Gunner Peterson. A trainer enters the trainer's name, gender and expertise in fields 714. The example of FIG. 2 illustrates three items of trainer information in fields 714. However, trainer console 710 is configurable within system 100 to enable more or less fields 714 and thus more or less items of trainer information to be provided. Trainer console 710 further enables a trainer to specify at least one characteristic of trainees that will be referred to that trainer by system 100. In the example of FIG. 2, trainer console 710 enables a trainer to select at least one desired trainee characteristic from examples types “age range” and “gender.” While only two trainee characteristics are illustrated in FIG. 2, other embodiments of the invention enable selection of a larger or lesser number of characteristics of desired trainees to be specified.

An exemplary second trainer console is illustrated at 722. Trainer console 722 is similar in operation to trainer console 710. While only two trainer consoles are illustrated in FIG. 2, it will be apparent upon reading this specification that a virtually unlimited number of trainer consoles are possible in various embodiments of the invention. The trainer consoles provided by trainer console generator 700 of system 100 enable a plurality of trainers to interact with system 100 using the trainers' respective computer systems as configured by training console generator subsystem 400.

### FIG. 2 Matching Unit 393—Detailed Description

Matching unit 393 of system 100 compares the trainer and trainee data stored respectively in trainee data storage 242 and trainer data storage 248. Matching unit 393 carries out the comparison with reference to matching criteria received from trainer and trainee consoles. Matching unit 393 provides an output indicating trainer-trainee matches. The matches are provided to console generating unit 400. Matching unit 393 further provides an output indicating matches to communication subsystem 800. Communication subsystem 800 enables a communication link between matched trainer and trainee consoles based on match indicating signals received from matching unit 393 and console identifiers stored in device tables 240. Console generating unit 400 generates respective trainee and trainer consoles including information relating to trainee and trainer matches, and provides the consoles to respective corresponding matched trainee and trainer computer systems.

### Matching Signal—Trainee's View

As described above, matching unit 393 provides an indication of matches to console generating subsystem 400. In the example of FIG. 2, matching unit 393 operated to match trainee Bob Jones to Diet & Nutrition trainers Barb Broccoli and Patty Peas, golf trainer Arnold Potter and Fitness trainer Gunner Peterson. Accordingly, matching unit 393 provides a match indicating signal including information about the above trainers matched to trainee Bob Jones. Trainee console generator 500 generates trainee console 507 based on the signal received from matching unit 393. Console 507 displays Bob Jones' matched trainers. In the example, under diet and nutrition, matched trainers Barb Broccoli and Patty Peas are displayed.

### Matching Signal Trainer View

As described above matching unit 393 operated to match trainee Bob Jones to trainer Arnold Potter in the trainer category “golf”. Matching unit 393 provides a signal to trainer console generator 700 to generate a trainer console 718 for trainer Arnold Potter. Based on the matching signal, trainer console 718 displays matched trainee names, including Bob Jones, in an area 712 of a display portion of trainer Arnold Potter's trainer console 718.

Similarly, matching unit 393 operated to match trainee Bob Jones to trainer Gunner Peterson in the trainer category “fitness”. Matching unit 393 provides a signal to trainer console generator 700 to generate a trainer console 718 for trainer Gunnar Peterson. Based on the matching signal, trainer console 718 displays matched trainee names, including Bob Jones, in an area 713 of a display portion of trainer Gunnar Peterson's trainer console 715.

### FIG. 3 GUI—Trainee Console 505

FIG. 3 illustrates an example of a display portion of a trainee console 505 according to an embodiment of the invention. In this example matching unit 393 provided an indication that trainers Gunnar Peterson 301 and Arnold Potter 302 matched the criteria provided by trainee A, Bob Jones. Trainee console generator 500 generated trainee console 505 associated with trainee Bob Jones based on the matching indication received from matching unit 393. Communications unit 800 enabled trainee console 504 to be provided to the computer system of Bob Jones based on a matching indication it received from matching unit 393.

In one embodiment of the invention trainee console 505 displays video clips (301 and 302 respectively) of trainers Gunnar Peterson and Arnold Potter for viewing by a trainee, for example, by trainee A, Bob Jones. In some embodiments of the invention, console 505 further provides a status indicator 305 indicating whether a trainer is online. Console 505 further provides controls, including a selector 307 enabling a trainee to select a displayed trainer as a personal trainer candidate for the trainee. In one embodiment of the invention, trainee console 505 generates a selection signal for matching unit 393 indicating the trainee's selection of a candidate trainer.

In one embodiment of the invention, trainee console generator 500 provides console 505 with a control 324 enabling a trainee to initiate a live interview with a matched trainer. In response to activation of control 324, trainee control console 505 provides a signal to console generator subsystem 400 indicating a trainee's selection of ‘live interview’. In response to receiving the live interview request signal, console generator subsystem 400 provides a request indication to the console of the corresponding trainer. The trainer's console enables the trainer to accept or decline the live interview request. If the request is accepted subsystem 400 provides trainee and trainer consoles to the requesting trainee and the accepting trainer. In one embodiment of the invention, the trainer and trainee consoles include video and audio device interfaces. The video and audio device interfaces enable real time video and audio communication between the trainer and the trainee. (Best illustrated in FIG. 5). For example, in one embodiment of the invention subsystem 400 enables video-teleconference between a requesting trainee and an accepting trainer via video cameras and audio devices coupled to the trainer and trainee consoles.

In response to receiving a trainee's selection signal, matching unit 393 provides a signal to trainer console generator 700 indicating the trainee identification of the requesting trainee and the trainer identification matching the selected trainer. Trainer console generator 700 provides an indication to the trainer system associated with the trainer identification that the identified trainee has requested the services of that trainer.

### FIG. 4 GUI Trainer Console 710

FIG. 4 illustrates an example portion of a trainer console 710 according to an embodiment of the invention. In this example matching unit 393 provided an indication that trainee Bob Jones matched the criteria provided by trainer 1, Arnold Potter. Trainee Bob Jones requested trainer Arnold Potter as a trainer. Trainer console generator 700 generates trainer console 710 for trainer Arnold Potter based on the signal received from matching unit 393. Communications unit 800 enables trainer console 710 to be provided to the computer system of Arnold Potter based on the matching indication it received from matching unit 393.

Trainer console 710 enables a trainer, for example trainer Arnold Potter to accept a request for the trainer's services by a trainee. For example, in one embodiment of the invention, trainer console 71 provides a picture or video of the requesting trainee, e.g. Bob Jones, in a video display portion 407, of trainer console 710. In one embodiment of the invention, information about the requesting trainee, e.g., Bob Jones is provided for display in an information display portion 403 of trainer console 710.

Trainer console generator 700 further provides controls 411, 409 enabling a trainer, e.g., trainer Arnold Potter, to indicate granting of a trainee's request. In one embodiment of the invention, console generator 700 provides a control 450 enabling a trainer to initiate a live interview with a matched trainee. Selection of control 450 causes trainer control console 710 to provide a signal to matching unit 393 indicating a trainer's selection of ‘live interview’. In response to receiving the live interview signal, matching unit 393 signals communication unit 800 to configure a trainer console 710 of the requesting trainer and trainee console 505 of a matched trainee for video communication, for example via video-teleconference enabled by video cameras coupled to the trainer and trainee consoles.

### FIG. 5 Training System 100—Detailed Description

FIG. 5 is a block diagram of training system 100 configured to establish communication links between consoles of matched trainers and trainees via communication subsystem 800 according to an embodiment of the invention.

### Trainee Console 505

As illustrated in FIG. 5, console generating subsystem 400 generates a trainee console 505 implemented on a computer system of trainee A “Bob Jones”. Trainee console 505 comprises display interface 534, a video capture interface 530, selector controls 532, user operable input device 531 and communication port 536. Console generating subsystem 400 also provides similar trainee consoles for trainee B, “Sally Smith.” Two trainees are illustrated in the example of FIG. 5. However, it will be understood upon reading this specification that system 100 is not limited with respect to a number of trainee and trainer consoles provided.

### Trainer Console 710

As illustrated in FIG. 5, console generating subsystem 400 generates a trainer console 710 implemented on a computer system of trainer 1 “Gunnar Peterson”. Trainer console 710 comprises display interface 734, a video capture interface 730, selector controls 732, user operable input device 731 and communication port 736. Console generating subsystem 400 also provides similar trainee consoles for trainers 2 and 3. Three trainers are illustrated in the example of FIG. 5 for purposes of explanation. However, it will be understood upon reading this specification that system 100 is not limited with respect to a number of trainee and trainer consoles provided.

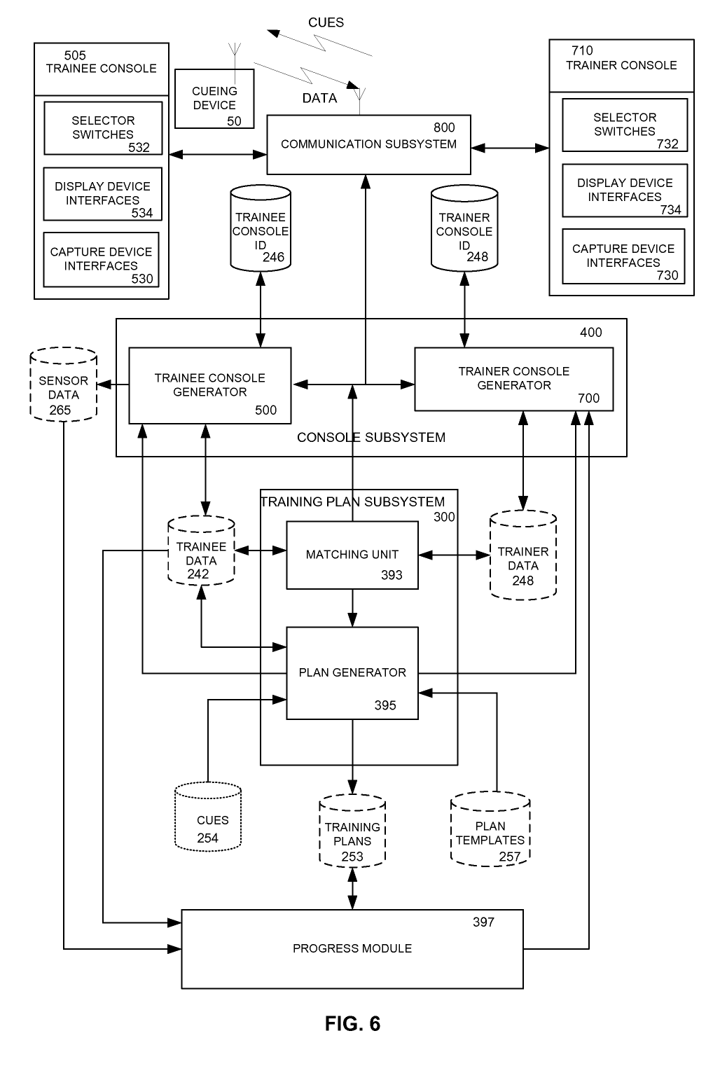

### FIG. 6 Progress Module and Cueing Device 50 Interface

FIG. 6 is a block diagram of training system 100 including a progress module 397 according to an embodiment of the invention. As described above, training system 100 comprises a console generating subsystem 400 coupled to a communication subsystem 800 and to a training plan subsystem 300. Training plan subsystem 300 includes a plan generator 395 and a matching unit 393. Plan generator 395 generates a training plan for a trainee who has been matched to at least one trainer by matching unit 393.

Console generating subsystem 400 provides graphical user interfaces, interactive controls, user displays and other functions, controls and indicators implementing the features of the invention described herein. Console generating subsystem 400 further provides consoles delivering personalized training plans to a trainee computer system. The personalized training plans are generated by training plan subsystem 300 based, at least in part on trainee data stored in data storage subsystem 200, and in part on plan modification data received from a trainer console. A trainer interacts with the trainer console to provide plan modification data. The modification is based, for example, on the trainer's communication with the trainee via system 1 00.

In one embodiment of the invention a personalized training plan for a trainee is stored in plan storage unit 253 of data storage unit 200. The trainee provides trainee data comprising plan progress information to system 100. In one embodiment of the invention, the trainee provides plan progress data via the trainee console implemented on the trainee's computer system. In some embodiments of the invention, the trainee provides plan progress data via cellular telephone or other personal communication device.

System 100 stores the trainee's progress data in trainee data storage 242. In some embodiments of the invention trainee progress is determined, at least in part by evaluating training parameters sensed by electronic sensors. The sensors are coupled to the trainee or to training equipment of the trainee. Sensed training parameter values are provided to system 100 via the trainee's console. The sensed training parameters are stored in sensor data storage unit 265.

Training progress module 397 receives trainee data from trainee data storage 242 and, in some embodiments from sensor data storage unit 265. Training progress module 397 further receives training plan data for the trainee from training plan storage unit 253. For example a training plan comprises a target weight of 130 lbs for trainee Doe at week 7 of a training plan. At week 7 Doe measures her weight and provides the weight measurement to system 100 via Doe's training console. The week 7 weight measurement is stored in trainee data storage 242. At week 7, training progress module 397 compares the trainee-provided progress data, e.g., Doe's weight data to Doe's training plan data. Training progress module 397 provides an indication of training progress based on the comparison. For example, if Doe's weight data indicates Doe's weight is 140 pounds, training progress module 397 provides a progress report to Doe's training console. The progress report indicates the training goal has not been achieved. In some embodiments of the invention, training progress module 397 adjusts Doe's stored training plan to modify the plan or the plan targets in accordance with the difference between a plan target and indications of training progress.

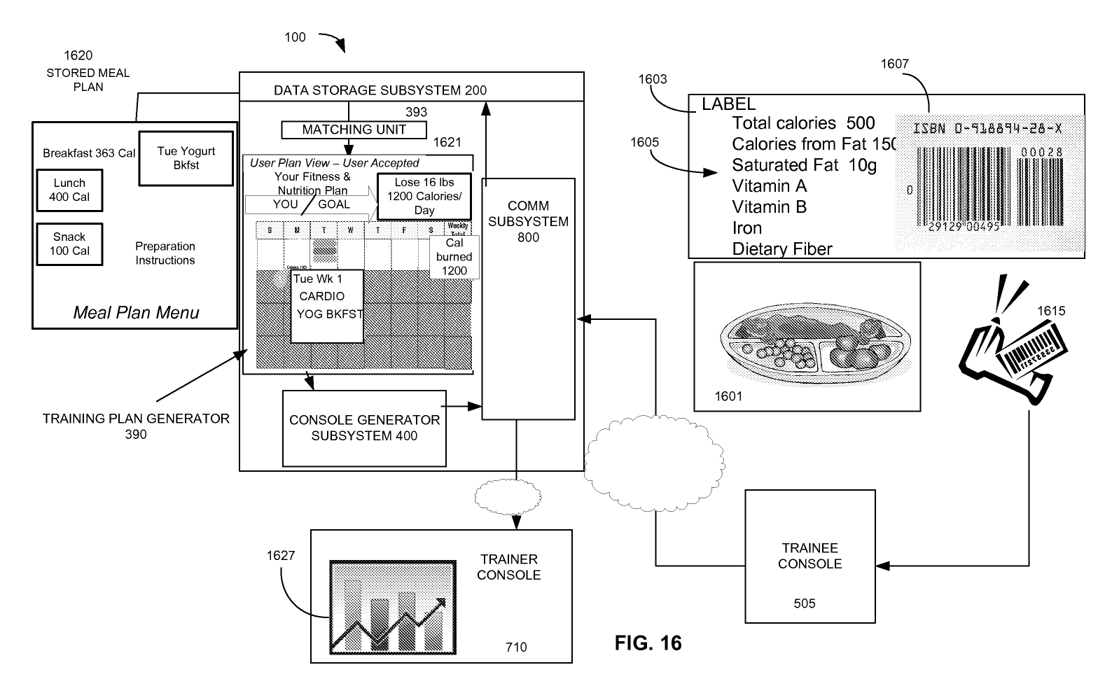

### FIG. 16 Example Embodiment

FIG. 16 illustrates an embodiment of the invention wherein a sensor comprises a hand held scanner 1615. The hand held scanner 1615 is coupled to a trainee console 505 implement on a trainee system via a wired or wireless communication link. A trainee uses the scanner to scan a label 1615 of a pre-packaged meal 1601. The label 1615 is coded to represent characteristics 1605 of the meal. For example, the label 1615 is coded to provide number of calories in the meal, amounts of vitamins and minerals, fat amounts, etc. The information about the meal 1605 is provided by the trainee console 505 to system 100. System 100 stores the information in data storage subsystem 200 in association with a dietary component, for example a meal plan 1620 of an identified trainee's training plan.

In response to a request for training plan information for that trainee, training plan generator 390 retrieves the information 1605 from data storage subsystem 200. In one embodiment of the invention, training plan generator 390 uses the information 1605 to generate a signal indicating the trainee's progress with respect to the dietary component of the trainee's training plan 1621. In another embodiment of the invention training plan generator 390 uses the information to generate a signal predicting a trend in the trainee's weight, e.g., either up, or down, based on the information about the meal. The trend is represented graphically and displayed in a display area of trainer console 710 as indicated at 1627. In some embodiments of the invention the graphic representation is generated for display on a trainee display device implemented on a trainee console.

In one embodiment of the invention a trainer generates a customized training plan for a matched trainee. Trainer console subsystem generates a console enabling the trainer to begin the plan generation process by selecting a template training plan for the trainee. As described above with respect to FIG. 1, a template data storage unit 257 stores template training plans. A template training plan is a generic training plan configured before being stored in data storage unit 257. Data storage unit 257 is capable of storing a variety of training plan templates.

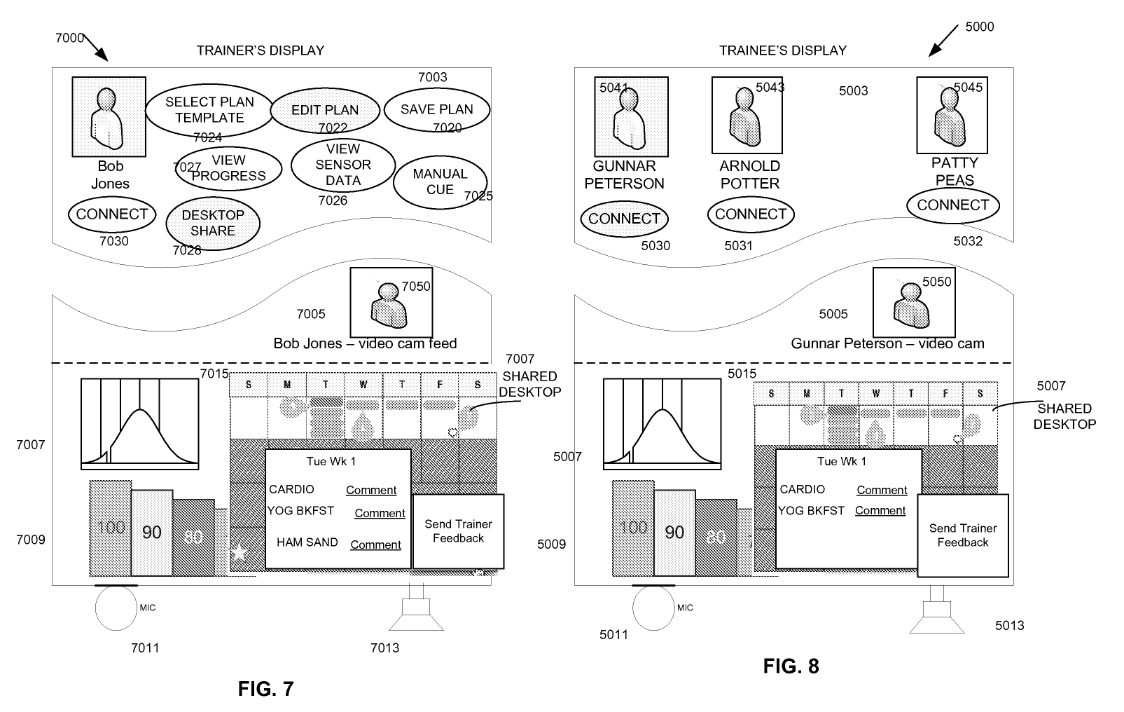

Plan generator 395 of system 100 enables a trainer to customize a template training plan to provide a personalized training plan for a trainee. This process is described in more detail in connection with FIGS. 7, 9 and 10. In one embodiment of the invention a personalized training plan is configurable to include at least one cue. Cues and their associated configuration information are stored in cue storage 254.

Once a personalized training plan is created, the plan is stored in training plan storage 253. As a trainee executes components of a training plan, system 100 receives data related to the trainee's execution. For example, some embodiments of the invention receive data related to trainee performance as sensed by at least one sensor associated with the trainee. Sensor data is collected over time and stored in sensor data storage 265. Progress module 397 is configured to compare components of a training plan to stored sensor data for a trainee. Progress module 397 determines the effectiveness of a training plan for a trainee based on evaluation of the sensed data with respect to the training plan. In some embodiments of the invention progress module 397 is capable of generating progress reports based on the evaluation of trainee progress. The progress reports are provided for display to trainers and their matched trainees.

### FIG. 7 Trainer Console 710 Example Controls and Interfaces

FIG. 7 illustrates an example trainer console 7000 generated by trainer console generator 700 of system 100. Trainer's console 7000 comprises a control panel portion 7003, a video display portion 7005 and a training plan display portion 7007.

### Control Panel 7003

The example control panel portion 7003 illustrated in FIG. 7 comprises a plan template selector 7024, a plan editing control 7022, a plan save control 7020, a sensor data viewing control 7025, a manual cue control 702, a desktop sharing control 7028 and a connect selector 7030.

### Plan Template Selector 7024

When selected by a control panel operator, template selector 7024 causes console 7000 to send a template selector signal to training plan generator 390 of training plan subsystem 300 via communication subsystem 800 of system 100.

In response to receiving the template selector signal, plan generator 390 retrieves a plurality of plan templates from template storage unit 257 (best illustrated in FIG. 1.). The plan templates are provided to trainer console generator 700. Trainer console generator 700 generates a trainer console (not shown) including the plan templates retrieved from template storage unit 257. System 100 provides the trainer console, including selectable plan templates to the requesting trainer system. When implemented on the requesting trainer system, the trainer console enables a trainer to select a plan template from the plurality of plan templates displayed on the trainer console.

### Edit Plan Selector

The selected plan template is provided by system 100 to the trainer system as a trainer console. Once the plan template is displayed on the trainer console, the “edit plan” selector 7022 enables the trainer to adjust the selected plan template by providing trainee related data to create a personalized training plan. The adjusted plan is stored as a training plan in training plan storage 253 of data storage unit 200 by selecting the “save plan” selector 7020.

In one embodiment of the invention trainer console 7000 displays a training plan 7015 in a display area of the console 7000. A ‘desktop share’ control generates a signal to system 100 to provide a shared desktop view to a matched trainee console (example trainee console shared desktop illustrated in FIG. 8 at 5007). In that manner a trainer and a matched trainee are enabled to participate simultaneously to customize a plan template for the matched trainee.

In one embodiment of the invention, trainee devices include sensors. Sensor data is provided from a trainee device to system 100. Trainer console 7000 enables a trainer to view the sensor data for a matched trainee by selecting a ‘view sensor data’ selector 7026. In that case, sensor data is displayed in a display portion 7007 of trainer console 7000. In one embodiment of the invention a trainer is enabled to view an indication of trainee progress for a training plan by selecting ‘view progress’ selector 7027. In that case, system 100 provides an indication of trainee progress, for example graph 7009, for display on trainer console 7000.

### FIG. 8 Trainee Console 705 Example Controls and Interfaces

FIG. 8 illustrates a display portion of a trainee's console according to an embodiment of the invention. Trainee's console 5000 comprises a control panel portion 5003, a video display portion 5005 and a training plan display portion 5007. The example control panel portion 5003 illustrated in FIG. 8 includes a connect selector 5030.

In one embodiment of the invention trainer console 5000 displays training plan 5015 in a display area of the console 5000. A ‘desktop share’ control generates a signal to system 100 to provide a shared desktop view to a matched trainer console (example trainer console shared desktop illustrated in FIG. 7 at 7007). In that manner a trainer and a matched trainee are enabled to participate simultaneously to customize a plan template for the matched trainee.

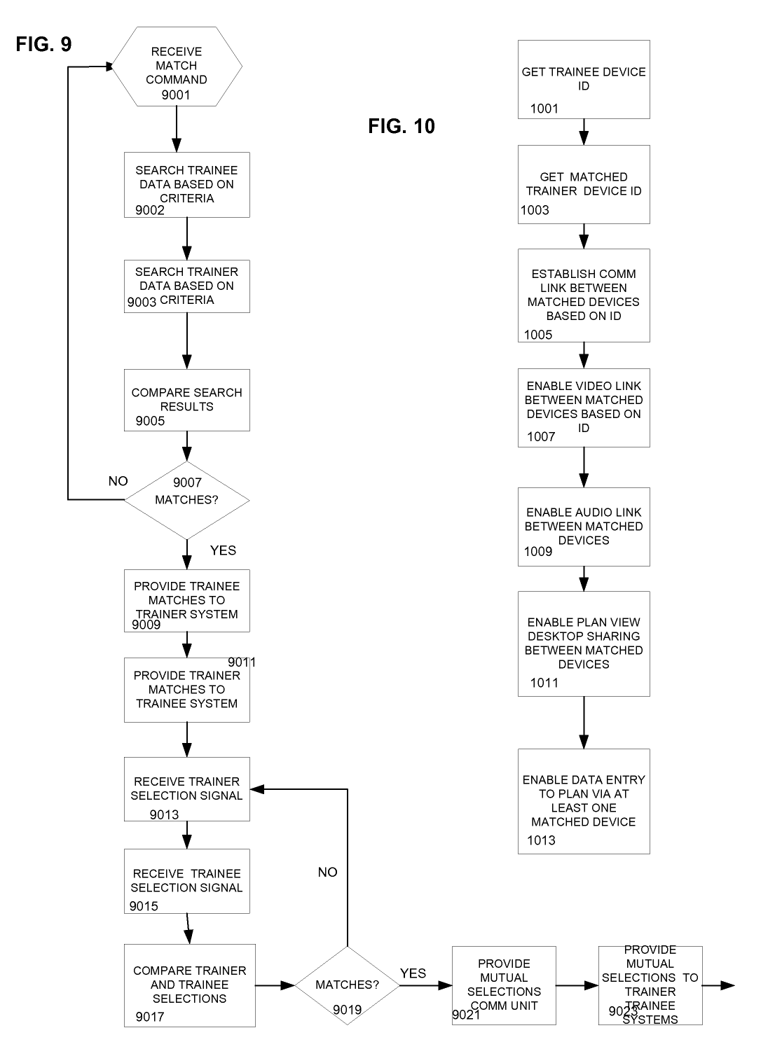

### FIG. 9 Matching Operation 900 Steps Flowchart

FIG. 9 is a flowchart illustrating steps of a matching method according to an embodiment of the invention. The method begins at 9001 when matching unit 393 of system 100 receives a match command from processor 900. A match command is provided to matching unit 393 when a request to generate matches is received by system 100. Both a trainee console and a trainer console are capable of providing a match command to system 100.

In a typical match pre-operation, trainee data and trainer data are received by system 100 from a trainee console and a trainer console respectively. The received trainer and trainee data are stored in trainer and trainee data tables 248 and 242 respectively of personal data table storage 260 of data storage subsystem 200. In addition, trainer and trainee search criteria are received from trainer and trainee consoles respectively. The trainer and trainee search criteria are provided to a temporary storage means accessible to matching unit 393 during a match operation.

It will be understood that storage means storing trainer and trainee search criteria need not be physically co-located with any other components of matching unit 393. Those of ordinary skill in the art will appreciate that memory is distributable among a variety of storage devices and device locations in any given system. As long as trainer and trainee matching criteria are stored in at least one storage means accessible to matching unit 393, so as to be retrievable by matching unit 393 for matching operations, any physical location of such a storage means is suitable for configuring system 100 in accordance with the principles of the invention described herein.

In response to the receiving a match command from processor 900, matching unit 393 searches trainee data stored in trainee data tables 242 based on trainer search criteria, as indicated at 9002. Likewise, in response to the receiving a match command from processor 900, matching unit 393 searches trainer data stored in trainer data tables 248 based on trainee search criteria, as indicated at 9003.

Matching unit 393 compares the results of the search, as indicated at 9005. Matching unit 393 determines if a match exists, as indicated at 9007. If no match exists, matching unit 393 waits for another match command as indicated at 9001. If at least one trainer-trainee match exists, matching unit 393 provides information about trainee matches to trainer console generator 700, as indicated at 9009. Matching unit 393 provides information about trainer matches to trainee console generator 500, as indicated at 9011.

In one embodiment of the invention system 100 provides information about matches to trainer and trainee systems via trainer and trainee console generators 700 and 500 respectively. Trainer and trainee consoles are generated by console generating system 400. The consoles display the corresponding respective matching trainers and trainees.

Trainee and trainer consoles enable a trainee and a trainer to select at least one of the displayed matches. Matching unit 393 receives a trainer selection signal from a trainee console, as indicated at 9013. Matching unit 393 receives a trainee selection signal from a trainer console, as indicated at 9015. Matching unit 393 compares the received trainer and trainee selections, as indicated at 9017. Matching unit 393 determines if any trainers and trainees have mutually selected each other, as indicated at 9019.

If matching unit 393 determines mutually selected trainers and trainees exist, matching unit 393 provides a signal indicating the mutually selected trainers and trainees to communications subsystem 800 (as indicated in FIG. 1), as indicated at 9021. In response to receiving this signal from matching unit 393, communication subsystem 800 establishes communication links between matched trainer and trainee consoles in accordance with the matching results provided by matching unit 393.

Mutually selected trainees are displayed on a matched trainer's console. Mutually selected trainers are displayed on a matched trainee's console, as indicated at 9023.

### FIG. 10 Communication Link Steps 1000 Flowchart

FIG. 10 is a flowchart illustrating steps for establishing a communication link between mutually selected matched trainers and trainees according to an embodiment of the invention. A console id associated with a trainee that has been matched with at least one trainer, and mutually selected by that trainer is retrieved from trainee console ID storage 246 of device tables 240 of data storage subsystem 200, as indicated at 1001. Likewise a console id associated with a trainer that has been matched with at least one trainee, and mutually selected by that trainee is retrieved from trainer console ID storage 248 of device tables 240 of data storage subsystem 200, as indicated at 1003.

Based on the trainer and trainee console identifiers retrieved in steps 1001 and 1003, communication subsystem 800 establishes a communication link between the identified consoles, as indicated at 1005.

In one embodiment of the invention system 100 enables a matched trainer and trainee to develop a training plan during a live video session. In that case, communication subsystem 800 enables a video link between the matched devices based on the matched trainer and trainee console identifiers, as indicated at step 1007. Communication subsystem 800 further enables an audio link between the matched devices based on the matched trainer and trainee console identifiers, as indicated at step 1009.

According to some embodiments of the invention system 100 enables a matched trainer and trainee to share a desktop display of a template training plan, or a personalized training plan, as indicated at 1011. Further embodiments of the invention enable a trainer, and in some embodiments a trainee, to enter data and to adjust a desktop shared plan, as indicated at step 1013. In that manner system 100 enables a personal training plan to be developed for a trainee during a live consultation with a trainer. Thus, through the personal interaction between a trainer and a trainee, the trainer's expertise is more readily brought to bear on the trainee's individual needs and goals.

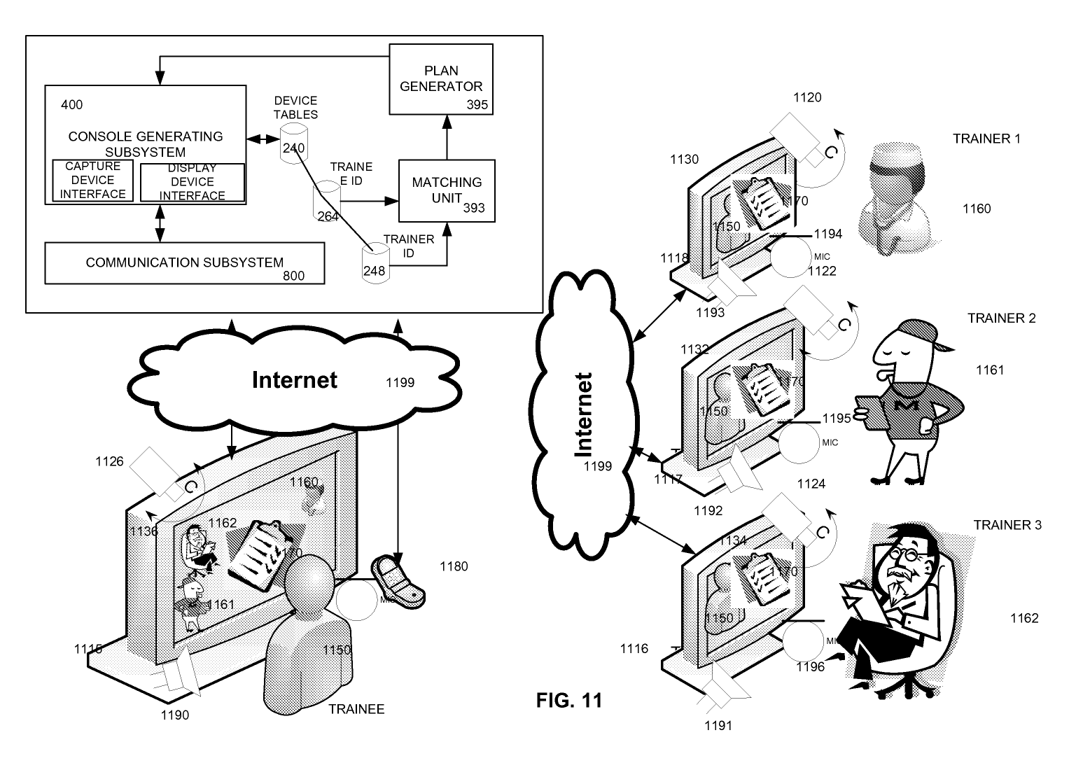

### FIG. 11 System 100 Multiple Trainer Example

FIG. 11 is a pictorial diagram illustrating a trainee system configured for communication with more than one trainer system according to an embodiment of the invention. System 100 provides a trainee console 1136 to a trainee system 1115. At the same time system 100 provides trainer consoles 1130, 1132 and 1134 to trainers 1160, 1161 and 1162 respectively. Trainer console capture devices, in this case video cameras 1124, 1122 and 1120 respectively capture video of each corresponding trainer. The captured video is displayed to trainee 1150 on a video display portion of trainee console 1136.

Similarly, a video capture device 1126 of trainee console 1136 captures video images of trainee 1150. System 100 provides the capture images of trainee 1150 to trainers 1160, 1161 and 1162. System 100 enables a training plan 1170 to be simultaneously observed on the trainee's console as well as the consoles of each trainer.

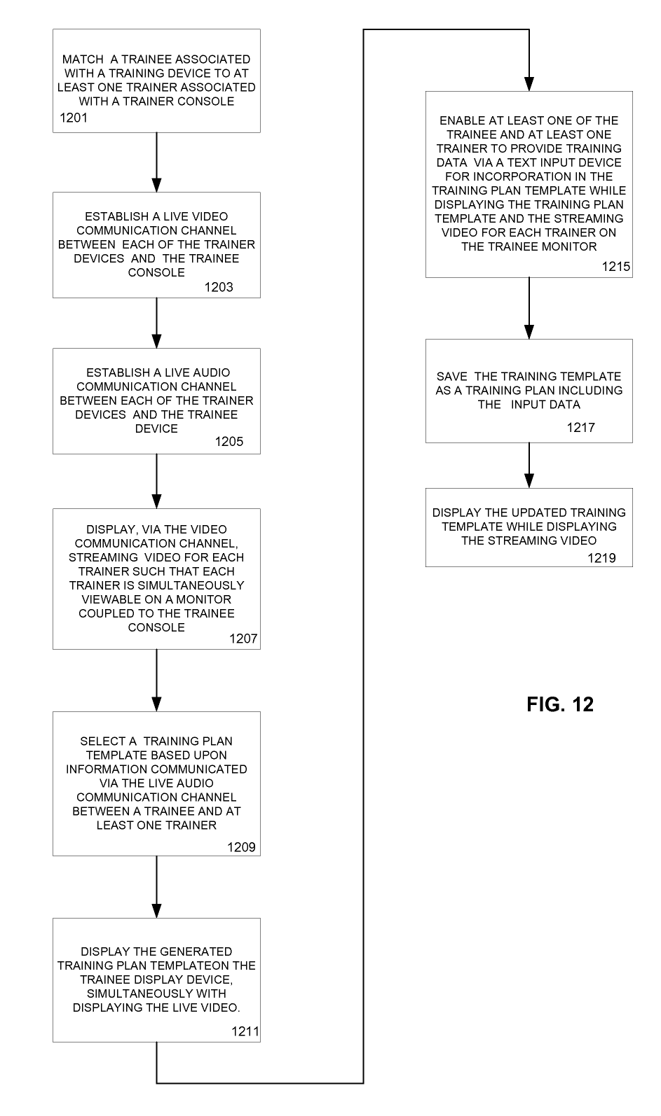

### FIG. 12 Plan Generation Flowchart

FIG. 12 is a flowchart illustrating steps of a method for generating a training plan according to an embodiment of the invention. A trainee associated with a training console is associated with at least one trainer. The trainer is associated with a trainer device as indicated at 1201. A live video communication channel is established between each matched trainer and trainee console, as indicated at 1203. A live audio communication channel is established between each matched trainer and trainee consoles as indicated at 1205.

Streaming video is displayed via the video communication channel for each trainer such that each trainer is simultaneously viewable on a monitor coupled to a matched trainee console, as indicated at 1207. A training plan template is selected by a trainer for association with a matched trainee, as indicated at 1209. Selection of the training plan template is based, at least in part, on information communicated between the trainer and a matched trainee during the video and audio communication sessions.

The selected training plan template is displayed on both the trainer console and a matched trainee console simultaneously with displaying the live video, as indicated at 1211. At least one of the trainee and at least one trainer is enabled to provide training data via a text input device associated with the trainee and trainer consoles. The data is incorporated in the training plan while displaying the training plan and the streaming video to the trainee and at least one matched trainer, as indicated at step 1215.

The training plan template, including the input data, is saved as a training plan and stored in training plan storage 253, as indicated at 1217. The updated training plan is displayed to both the trainer and a matched trainee while displaying the streaming video, as indicated at step 1219.

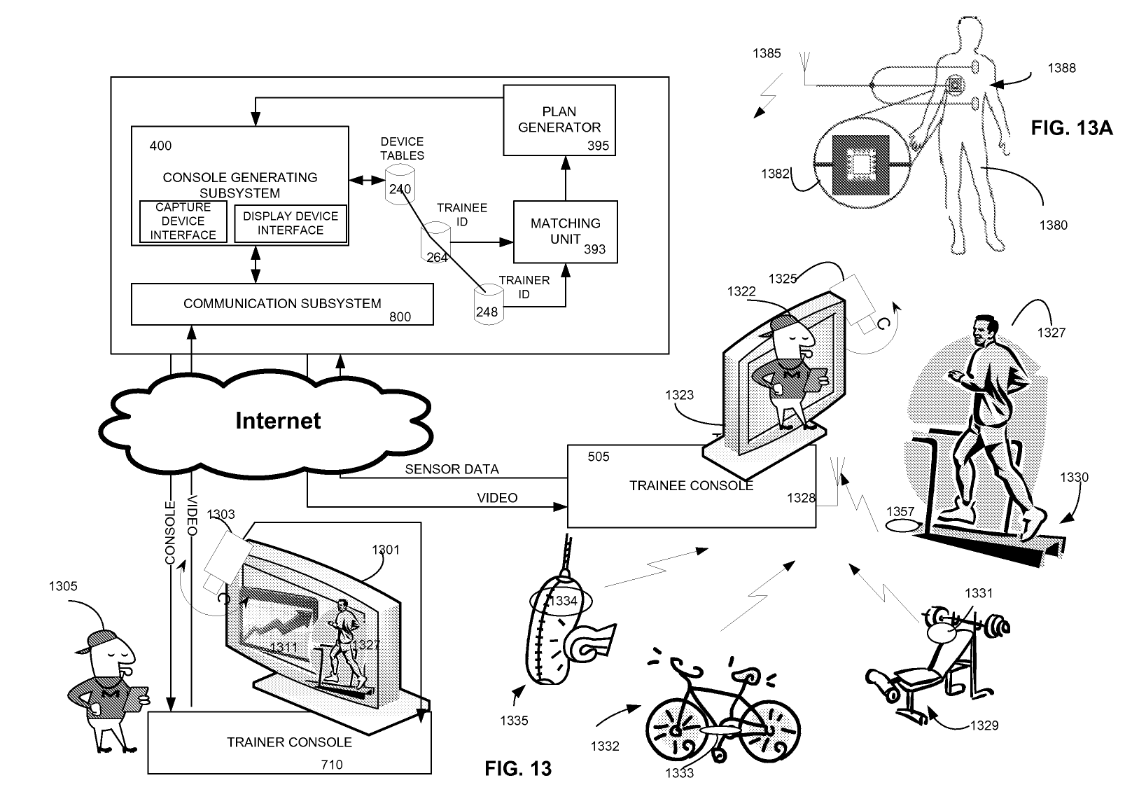

### FIG. 13 System 100 Example Home Training System

FIG. 13 is a pictorial diagram illustrating a system of the invention configured for real time remote coaching according to an embodiment of the invention. A training site 1300 comprises training equipment. In the embodiment illustrated in FIG. 13 training equipment includes a treadmill 1329 a weight bench 1331, a stationary bicycle 1333 and a punching bag 1335. A trainee 1327 is shown using the training equipment, in this case treadmill 1329.

According to one embodiment of the invention, treadmill 1329 includes at least one sensor 1328. Sensor 1328 senses training parameters, for example, the speed of treadmill 1329. Other sensors associated with treadmill 1329 sense other training parameters, for example, a timer senses duration of a treadmill training session. Sensor 1328 transmits values for sensed training parameters to a receiving unit of training system 1320. The received sensed training parameters are provided as an input to the training console for which trainee system 1320 is configured. Configuration of a trainee system to implement a training console is discussed elsewhere in this specification in connection with console generating subsystem 400 illustrated, for example, in FIG. 1 at 400.

The received training parameter values are communicated to training system 100. Training system 100 receives the training parameter values for use in evaluating the trainee, for example, the trainee's current physical condition or progress in a training plan. In one embodiment of the invention received training parameter values are stored in sensor data storage 265 of data storage unit 260. (Illustrated in FIG. 1). Plan generator unit 390 transforms the sensed data into graphical representations related to trainee performance or progress with respect to a training plan. Plan generator unit 390 provides the representation information to console generating subsystem 400. Console generating system 400 provides graphical representations of trainee performance or progress based on stored, and in some embodiments, real time, sensor data. The graphical representations are provided to communication subsystem 800. Communication system 800 provides the console, including the graphical representations to a trainee or trainer system by configuring the system via a trainer or trainee console.

In other embodiments of the invention plan generator 390 compares stored sensor data to a training plan, for example to training plan goals related to the sensor data. In that embodiment, plan generator 390 provides an indication of trainee progress relative to the trainee's training plan. In some embodiments of the invention, for example in competitive training implementations, system 100 enables plan generator 390 to provide an indication of trainee performance or progress of the trainee relative to the performance or progress of other trainees. Console generating subsystem 400 generates a graphical representation of the indication of trainee performance for presentation on a trainer or trainee training console.

Similar to the treadmill example embodiment described above, a weight bench 1331 is equipped with a sensor 1330. Sensor 1330 senses parameters of a weight training session, for example, acceleration, or thrust, number of repetitions, time and other related parameters. Sensor 1330 transmits values for sensed training parameters to a receiving unit of training system 1320. The received sensed training parameters are provided as an input to the training console for which trainee system 1320 is configured.

FIG. 13 illustrates sensors 1333 and 1334 coupled, respectively to stationary bicycle 1332 and punching bag 1334. Sensors 1333 and 1334 sense parameters of a exercise sessions carried out using this equipment, for example, acceleration, or thrust, number of repetitions, time and other related parameters. Sensors 1333 and 1334 transmit values for sensed training parameters to a receiving unit of training system 1320. The received sensed training parameters are provided as an input to the training console for which trainee system 1320 is configured.

In one embodiment of the invention training plan generator 390 provides graphical representations of sensed training parameters to a trainer console for configuring a trainer system 1313. Trainer system 1313 displays the sensed training parameters for observation by a trainer 1305. In one embodiment of the invention trainee system 1320 includes a video camera 1325. Video camera 1325 provides real time video to system 100 for display in a video display portion of a trainer console implemented on trainer system 1313. In that manner, trainer 1305 may observe trainee 1325. In one embodiment of the invention, system 100 establishes an audio communication link between trainer system 1313 and trainee system 1320. Thus, trainer 1305 is enabled to provide real time feedback to trainee 1325 as a training task is being performed. In other embodiments of the invention, training plan generator 395 generates training plan components or progress reports based on sensed exercise parameters.

### Sensors

A number of sensors are presently commercially available and suitable for implementing sensors 1328, 1330, 1334 and 1333 according to the various embodiments of the invention described herein. Commercial accelerometers capable of sensing strike force, spatial orientation and acceleration of an object along three axes include the ADXL330 accelerometer available from Analog Devices headquartered in Norwood, Mass.

Some embodiments of the invention employ commercially available sports watches and foot devices comprising accelerometers to sense exercise related parameters, for example, speed and distance of runner 1327. In one embodiment of the invention, the sensed parameters are transmitted from the sensor to a receiver coupled to trainee system 1320 via cables or wires suitable for transmitting sensor signals. Alternative embodiments of the invention will employ Bluetooth, WIFI, Radio Frequency, Ultra wideband (UWB), and other short distance transmission techniques to transmit sensed parameter values from a sensor coupled to a training device to a trainee console.

In one embodiment of the invention a trainee follows a training plan, for example a training plan with a weight loss component. The trainee wears an accelerometer that senses bi-axial or tri-axial acceleration associated with the trainee's movement throughout a day. The sensed data is stored and used to quantify the rate at which the trainee is expending energy over time. In one embodiment of the invention, plan generator 390 carries out the quantification by techniques such as limb-stroke frequency and overall dynamic body acceleration. Plan generator 390 provides a training plan for the trainee based on the information about the trainee's expended energy.

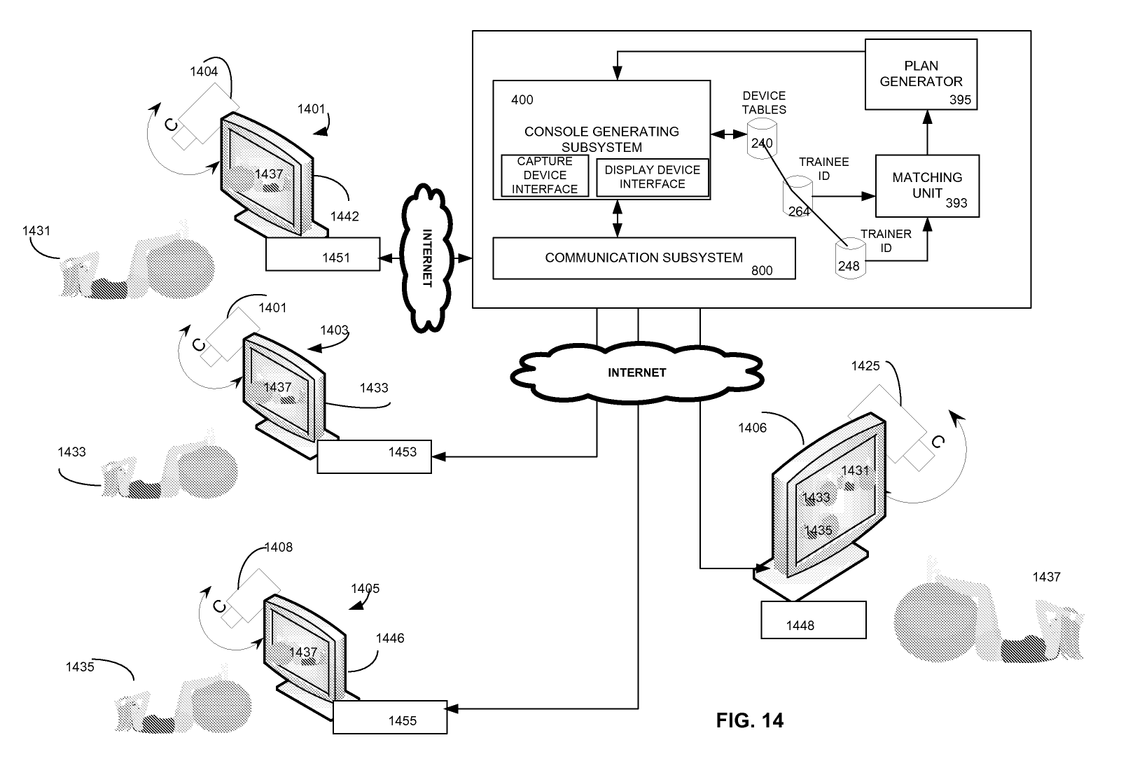

### FIG. 14 System 100 Example Interactive Exercise Class

FIG. 14 illustrates system 100 of the invention configured to provide an interactive exercise class by establishing communication links between a trainer console 1406 and trainee consoles 1401, 1403 and 1405. In the example illustrated, a class comprises trainees 1431, 1433 and 1435. Each trainee is separately located from the others, for example in the trainees' respective homes. While only three trainees are illustrated in the example of FIG. 14 it will be readily understood by those of ordinary skill in the art, upon reading this specification, the number of trainees comprising a class can be more or less than three while remaining within the scope of the embodiments of the invention presented herein.

Each trainee 1431, 1433 and 1435 is associated with a corresponding trainee computer system, 1401, 1403 and 1405 respectively. Video devices 1404, 1401 and 1408 are coupled to trainee computer systems 1401, 1403 and 1405 respectively. Display devices 1442, 1443, and 1446 are also coupled to trainee computer systems 1401, 1403 and 1405 respectively. Each trainee system communicates with system 100 via a communication link, for example, a local area network or wide area network such as the Internet.

For example, trainee system 1450 is coupled to system 100 via communication subsystem 800. Console generating subsystem 400 provides a trainee console to trainee system 1451. (See example console 5000 illustrated in FIG. 8.) The trainee console includes capture device interface 401 and display device interface 402. Capture device interface 401 enables a trainee console to receive data captured from devices such as video camera 1401, microphones, remote user operable controls, and other receivers. Display device interface 402 enables a trainee computer system to display video, text, graphics, control panels, menu's and other components of a trainee console on a display device coupled to trainee computer system 1452, for example display device 1442.

Similarly, trainer system 1448 is coupled to system 100 via communication subsystem 800. Console generating subsystem 400 provides a trainer console to trainer system 1448. (See example console 7000 illustrated in FIG. 7.) The trainer console includes capture device interface 401 and display device interface 402. Capture device interface 401 enables a trainer console to receive data captured from devices such as video camera 1425, microphones, remote user operable controls, and other receivers. Display device interface 402 enables a trainer computer system to display video, text, graphics, control panels, menu's and other components of a trainer console on a display device 1406 of trainer system 1448.

To configure system 100 for the example training class, matching unit 393 matches trainees 1431, 1433 and 1435 to trainer 1437 based on information stored in trainer and trainee information storage units of data storage subsystem 200 (best illustrated in FIG. 1). Plan generator 395 generates a plan for the class, for example a schedule and activity plan for trainees matched to trainer 1437. Plan generator 395 provides the plan to console generating subsystem 400. In addition to a schedule and activity plan, plan generator 395 provides device identifiers for each trainee computer system and the trainer system. In one embodiment of the invention, the device identifiers comprise internet address identifiers such as Internet Protocol (IP) addresses of the computer systems. A trainee or trainer device identifier is associated with each matched trainee and trainer console generated by console generating subsystem 400.

Communication subsystem 800 enables system 100 to provide trainee consoles comprising live video captured by trainer camera 1425 to be provided to computer systems 1451, 1453 and 1455. In that manner, trainees 1431, 1433 and 1435 can observe the motion of trainer 1437 during an exercise. Likewise, communication subsystem 800 enables system 100 to provide a trainer consoles comprising live video captured by trainee cameras 1401, 1403 and 1405 to be provided to trainer computer system 1406. In that manner, trainer 1437 can guide trainees 1431, 1433 and 1435 during the exercise.

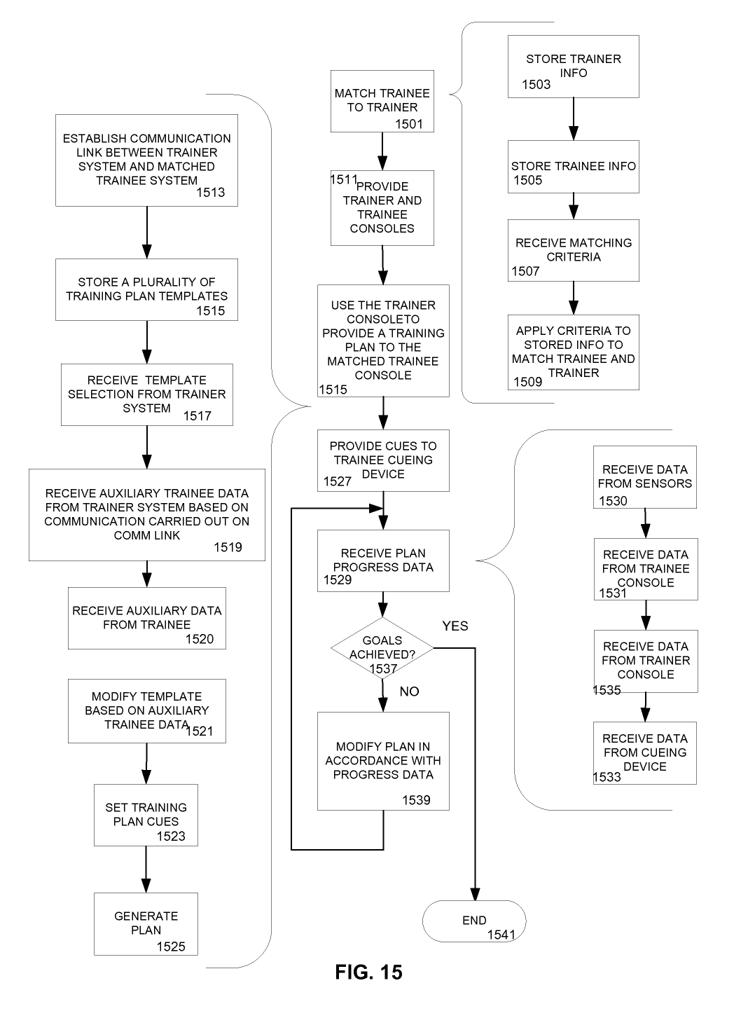

### FIG. 15 Training Method

FIG. 15 illustrates steps of a training method according to an embodiment of the invention. In general the method is carried out by system 100 implementing the following steps under control of processor 900. Matching unit 393 of system 100 matches at least one trainee to at least one trainer at 1501. Matching unit 393 carries out this step based on information stored by system 100 in personal data tables 260 of data storage unit 200. Matching unit 383 provides the results of the matching step to training console generating subsystem 400. At 1511 training console generator 400 generates trainer and trainee consoles.

Trainer console generator 700 of console generating subsystem 400 provides a trainer console to the at least one matched trainer. Trainee console generator 500 provides a trainee console to the at least one matched trainee. At 1515 the trainer console is operated by a trainer, using a trainer computer system configured in accordance with the trainer console, to generate a training plan. The training plan is provided to console generating subsystem 400. (Illustrated in FIG. 5). Console generating subsystem 400 provides the training plan to a trainee by generating a matched trainee console including the training plan. The matched trainee follows the training plan to achieve the trainee's training goals. In one embodiment the training plan includes trainee cues. At 1527 communication subsystem 800 provides the cues to a cueing device 50 associated with the matched trainee.

At 1529 communication subsystem 800 receives data related to the trainee's progress with respect to the training plan. At step 1537 progress module 397 compares the received progress data to the training plan to determine if the trainee has achieved the training goals. If progress module 397 determines the results of the comparison indicate the trainee has reached the training goals the process terminates at 1541. If the results of the comparison by progress module 397 indicate the trainee has not reached the training goals, trainee progress is monitored by system 100 repeating the step of receiving plan progress data at 1529. The process repeats under control of processor 900 until the trainee reaches the training goals, or the process is otherwise terminated or suspended.

In one embodiment of the invention the step of matching a trainee to a trainer (1501) is carried out by system 100 receiving and storing trainer information at 1503. System 100 receives and stores trainee information at 1505. In some embodiments of the invention system 100 receives trainer and trainee information via an interactive web page provided to computer systems of users of system 100. Other embodiments of the invention receive trainer and trainee information via other communication devices, for example, via telephone, email, or other conventional communication techniques. System 100 then stores the received information in data storage unit 200 of system 100.

In one embodiment of the invention, regardless of the particular devices and approaches employed to receive trainer and trainee information, matching unit 393 applies matching criteria when matching at least one trainee to at least one trainer. In one embodiment of the invention communication subsystem 800 receives the matching criteria from one of a trainer console and a trainee console implemented on a trainer or trainee computer system respectively as indicated at 1507. Matching unit 393 applies the received criteria to the stored trainer and trainee information to identify a match between at least one trainee and at least one trainer at 1509.

In one embodiment of the invention the step of using the trainer console to provide a training plan to the matched trainee console (1515) is carried out by the following steps. Communication subsystem 800 of system 100 establishes a communication link between at least one trainer system and at least one matched trainee system at 1513. The trainer and the matched trainee communicate via the communication link to determine trainee information, for example, the trainee's health and fitness status and training goals. System 100 stores a plurality of training plan templates at 1515. A trainer operates the trainer console to communicate with training plan subsystem 300 of system 100. In that manner the trainer selects a training plan template for a matched trainee based on the information received by the trainer using the established communication link. The trainer's template selection is received by training plan subsystem 300 at 1517.

According to some embodiments of the invention a trainer provides auxiliary trainee data to system 100 for storage in aux data storage unit 269 of data storage subsystem 200. Auxiliary trainee data comprises information related to the trainee's experiences while carrying out a training plan. For example, a trainee may express a preference for one type of meal plan over another. In some embodiments of the invention a trainer provides auxiliary data to system 100 based on information the trainer receives from the trainee. In that case, system 100 receives the trainer-provided auxiliary data at 1519.

In some embodiments of the invention auxiliary data is received from the trainee, for example, using a trainee computer system configured as a trainee console. In one embodiment system 100 receives the auxiliary data while the trainee is communicating with the trainer via the established communication link. In some embodiments the trainee provides auxiliary trainee data for a training plan via the trainee's computer system, training console, telephone, text message or other communication means. At 1520 system 100 receives the auxiliary data from the trainee and stores the auxiliary data.

For training plans including cues, a trainer operates a trainer console to carry out a step of selecting cues from cue data storage 254 of data storage subsystem 200. Training plan generator receives the selected cues and provides the cues for the training plan at 1523. At step 1525 plan generator 390 generates the training plan, including the trainer-selected cues. In another embodiment of the invention, a trainee operates a trainee computer system implementing a trainee console, to select cues from cue storage 254. In that case training plan subsystem 300 provides a training plan including the trainee-selected cues.

While the invention has been shown and described with respect to particular embodiments, it is not thus limited. Numerous modifications, changes and enhancements will now be apparent to the reader.

We claim:

1. A personal training system comprising:
a data storage subsystem comprising data associated with trainers and trainees and data representing cues;
a matching system coupled to the data storage subsystem to match at least one of the trainers with at least one of the trainees based on the stored data;
a console generating subsystem configured to generate trainer and trainee consoles for matched trainers and trainees;
a training plan subsystem coupled to the console generating subsystem to receive commands from a generated trainer console, and to generate a training plan for a matched trainee in response to the commands;
the training plan including cues selected from the data storage subsystem via a control panel of the generated trainer console.

2. The personal training system of claim 1 further comprising a communication subsystem coupled to the training plan subsystem to provide the generated trainee console to a corresponding trainee computer system.

3. The personal training system of claim 2 wherein the communication subsystem includes:
a first communication port for transmitting the trainee console, including the training plan, to a trainee system; and
a second communication port for transmitting the training plan cues to a trainee cueing device in accordance with the training plan.

4. The personal training system of claim 2 further comprising:
a progress module coupled to the training plan subsystem,
the communication subsystem configured to receive sensed data from at least one sensor associated with the trainee console, and to provide the sensed data to the progress module;
the progress module providing an indication of progress with respect to the training plan based at least in part on the sensed data.

5. The personal training system of claim 1 wherein the console generating subsystem is configured to receive training plan information related to a trainee from at least one matched trainer console and to provide a training plan to the matched trainee console, the training plan based on the received trainee information, thereby enabling delivery of a trainer developed training plan to a matched trainee.

6. The system of claim 3 wherein at least one of the trainees is associated in a device table of the data storage system, with a trainee cueing device selected from the group: cellular telephones, personal digital assistants, laptop computers, notepad devices and electronic pagers.

7. A method for providing personal training comprising:
storing data associated with trainers, data associated with trainees and data representing cues in a data storage subsystem;
comparing the data associated with the trainers and the data associated with the trainees;
matching at least one trainer to at least one trainee based on the comparison;
generating corresponding trainer and trainee consoles in accordance with the results of the matching;
receiving commands from a control panel of the trainer console;
generating a trainee console including a training plan in response to the commands;
the training plan including cues selected from the data storage subsystem via the control panel.

8. The method of claim 4 including a step of transmitting the cues to a cueing device in accordance with the training plan.

9. The method of claim 4 including steps of:
receiving sensed data from a trainee console;
comparing the sensed data to the training plan;
providing a progress report relating to the training plan based on the comparison.

10. A method of providing personal training comprising steps of:
storing information related to trainers and trainees in a data storage system;
receiving criteria for matching trainees and a trainer;
matching a plurality of trainees to a trainer to define a training group by comparing the stored trainer and trainee information to the criteria;
receiving a trainer video signal from a video device coupled to a trainer system;
providing the trainer video signal to a display device of at least one of the plurality of matched trainees;
receiving a trainee video signal from a video device coupled to at least one trainee system;
providing the trainee video signal to a display device of the trainer system;
thereby enabling the trainer to observe the training group, and the training group to observe the trainer during a training exercise.

11. The method of claim 9 further including steps of:
receiving sensed data from a sensor coupled to at least one trainee device;
providing the sensed data to the trainer system for display on a trainer display, thereby enabling the trainer to observe sensed measures of trainee performance during a training exercise.
